(19) United States
(12) Patent Application Publication
(10) Pub. No.: US 2021/0221608 A1
(43) Pub. Date: Jul. 22, 2021

(54) ENHANCED COMMERCIAL WASTE CONTAINER LOAD RAIL WITH END CAPS

(71) Applicant: Kevin Paul Gavin, Northbrook, IL (US)

(72) Inventor: Kevin Paul Gavin, Northbrook, IL (US)

(21) Appl. No.: 16/745,207

(22) Filed: Jan. 16, 2020

(51) Int. Cl. B65F 1/14; B65F 1/02

(52) U.S. Cl. CPC B65F 1/141; B65F 2250/112; B65F 1/02

(57) ABSTRACT

The present disclosure relates to an enhanced rail for the bottom of a commercial waste container with an end cap design. The robust design will resist failure when the container is placed on the ground with increased surface area between rail and container and end cap connection to container when only one end of the rail touches first. It also allows for the reduction of rails on the container from three to two.

### BACKGROUND OF THE DISCLOSURE

### Field of the Invention

This disclosure relates to a base or bottom rail for a commercial waste container or dumpster that provides enhanced load bearing capability. In particular, when the containers are being set on the ground including at an angle and either the front/rear contact only on the front edge or rear edge of the rail.

### Description of the Related Art

The body of commercial waste containers or dumpsters may last ten to twelve years. Nevertheless, because of the combined weight of a full container and real-life working conditions of lifting to transfer waste to a haul vehicle and the subsequent placement of the container on the ground, there are several wear parts on the container, in particular, including the bottom rails. Over the course of the life of a commercial waste container or dumpster, the containers may be refurbished with the high wear parts including the bottom rails being replaced.

There are several existing designs of commercial waste container rails of various sizes and shapes some of which require two or three rails to be employed to support the container. Further improvements are sought in improving the robustness of the rail and improving the load bearing capabilities of container. This new load rail significantly increases the surface area that the force is dispersed with the roll formed edges of, for example, approximately ½″ on either side. The new load rail will transfer the load to the end caps and up the risers eliminating failures of the bottom puncturing through or rail being crushed. Additionally, further improvements are also sought to reduce the number of rails per container from three to two, which would significantly reduce cost in the process.

### SUMMARY OF THE INVENTION

It is an object of the present disclosure to provide improvements in load bearing capability of rails for commercial waste containers.

This and other objects may be attained by providing a rail comprised, for example, of roll-formed low carbon steel with in embodiments “U” shaped end caps that may be joggled to provide significantly increased load bearing capability.

The U shaped rail may also tie into a cap which can extend the force up the front/rear risers.

Other features and aspects will be apparent from the following detailed description, the drawings, and the claims.

### BRIEF DESCRIPTION OF THE DRAWINGS

FIG. 1 shows one embodiment of a container being placed on the ground.

FIGS. 2A and 2B show one embodiment of a rail.

FIG. 3 shows one embodiment of an end cap connected to a rail.

FIG. 4 shows one embodiment of a roll-forming diagram with bends.

FIG. 5 shows one embodiment of a three rail system.

FIG. 6 shows one embodiment of a two rail system.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, products, and/or systems, described herein. However, various changes, modifications, and equivalents of the methods, products, and/or systems described herein will be apparent to an ordinary skilled artisan.

In one embodiment this disclosure provides a rail comprised, for example, of roll-formed low carbon steel with “U” shaped end caps that may be joggled to connect to front/rear of a waste container to provide significantly increased load bearing capability.

In an effort to extend the life of a rail and increase the time between refurbishings, various shapes of rails and configurations of end caps have been considered and tested. In addition to the shape of the makeup of the rail, the configuration of the end cap is important to the design to provide a robust rail system. A T or U-shaped design(s) are preferred embodiment for a robust rail system. An endcap may be used to prevent a rail from collecting debris, such as stones, and dropping them onto a waste disposal vehicle windshield. Thus, the endcaps help to avoid damage to the waste vehicle during transfer to the vehicle. This is most important with front loading vehicles.

Another aspect of the disclosure is the reduction of rails on the container from three to two. A typical configuration includes three rails, but a preferred design includes two enhanced load rails due to the increased strength/rigidity. This not only reduces the cost of the rails, but as the rails are welded to the bottom by hand, labor is significantly reduced (by at least one third).

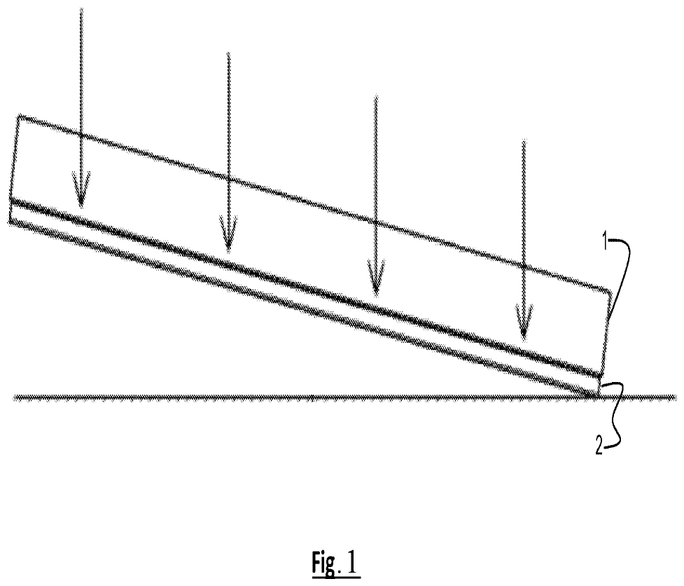

FIG. 1 shows a container 1 being placed on the ground with the full weight of the container on the end of a rail 2.

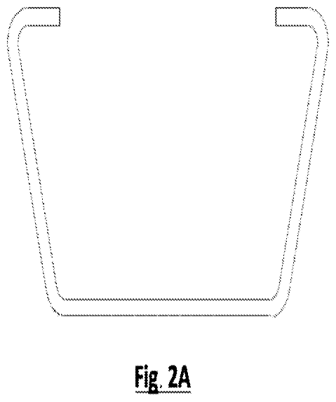

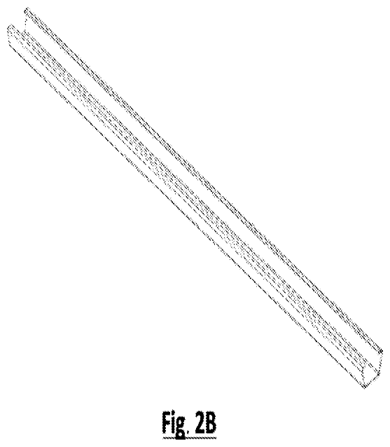

FIG. 2A shows one embodiment of a front view of a preferred design of a rail 2.

FIG. 2B shows one embodiment of a full view of a preferred design of a rail 2.

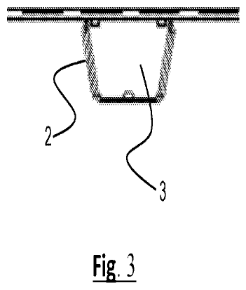

FIG. 3 shows one embodiment of a U-shaped end cap 3 connected to a rail 2. The U-shaped end cap 3 may overlap the bottom of the rail 2. In one embodiment, the U-shaped end cap may overlap the container front/rear by several inches in order to transfer force upon hitting ground up the front and/or rear of container.

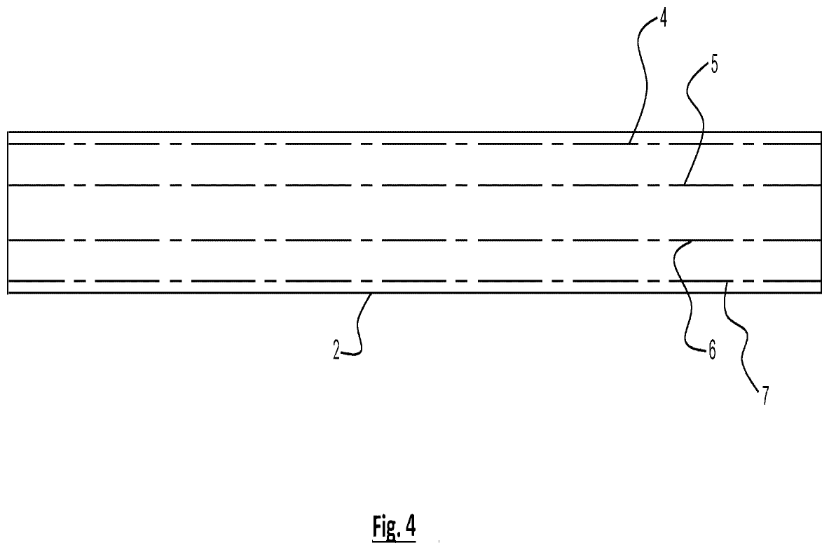

FIG. 4 shows one embodiment of a roll-forming diagram with bends (dashed lines) 4, 5, 6, and 7 to produce a desired shape of a rail 2.

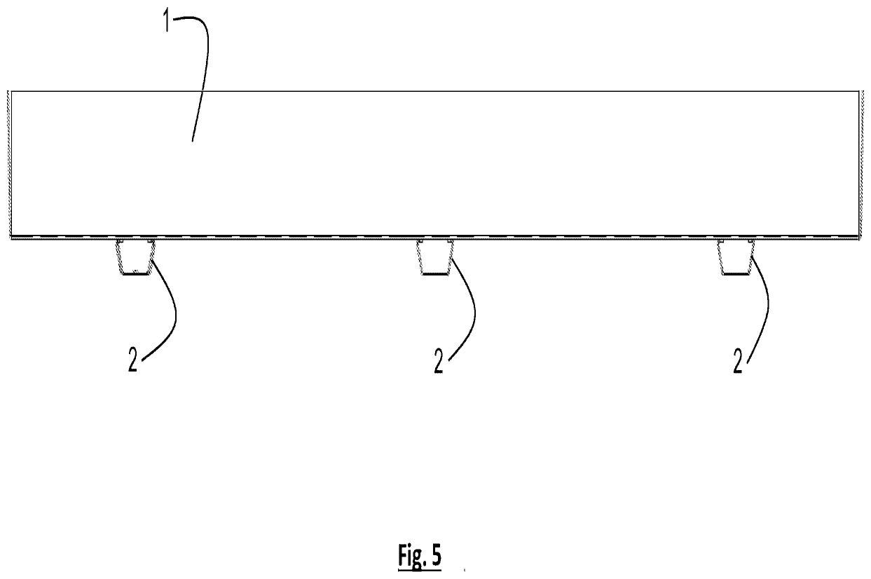

FIG. 5 shows one embodiment of a three rail 2 system. (Applicants note that the inventive rails 2 may be used in either a three rail system or a two rail system although a two rail system is preferred.)

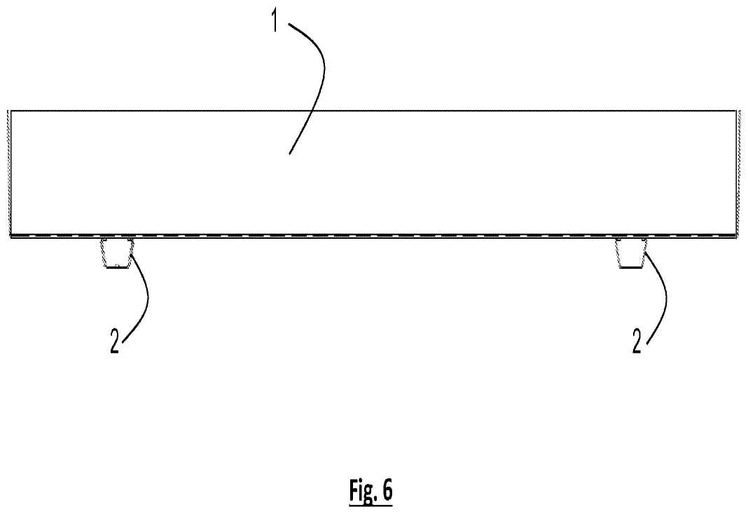

FIG. 6 shows one embodiment of a two rail system.

### EXAMPLE

Various shapes of rails were tested. Table 1 shows test data for two variations of rail design. As shown in Table 1, The U-shaped rail maximum stress is significantly lower (14.92% lower) for the U-shaped rail when compared with the T-shaped rail.

TABLE 1

| | Maximum Stress @ | Maximum Deformation @ |
|---|---|---|
| | 4000 lb | 4000 lb |
| T-Rail | 34.19 MPa (4,959 PSI) | 0.03 mm |
| U Rail | 29.09 MPa (4,219 PSI) | 0.03 mm |

Various iterations were made to find out (for each rail) the load where the material would reach its yield strength of 207 MPa (30,000 PSI). As shown in Table 2, the U-shaped rail requires approximately 2.5% more force to be applied for it to fail, when compared to the T-shaped rail.

TABLE 2

| | Load to reach Yield Stength (207 MPa) |
|---|---|
| T-Rail | 27,850 lb |
| U Rail | 28,550 lb |

While this disclosure includes specific examples, it will be apparent after an understanding of the disclosure of this application has been attained that various changes in form and details may be made in these examples without departing from the spirit and scope of the claims and their equivalents.

What is claimed is:

1. A load rail comprising rolled legs for a commercial waste container comprising a front and a rear comprising:
roll-formed low carbon steel;
an endcap.

2. A load rail for a commercial waste container of claim 1, wherein the endcap is U-shaped and joggled to the rail.

3. The load rail for a commercial waste container of claim 1, wherein the end cap varies in length to connect to a front or rear of the commercial waste container.

4. The load rail for commercial waste container of claim 1, wherein the rolled legs of the rail increase the surface area of the commercial waste container.

5. A commercial waste container comprising two load rails of claim 1.

6. A commercial waste container comprising three load rails of claim 1.
